(19) United States
(12) Patent Application Publication
(10) Pub. No.: US 2020/0073965 A1
(43) Pub. Date: Mar. 5, 2020

(54) METHOD FOR DETERMINING GAS RUPTURE EXPOSURE RADIUS VALUE BASED ON DISPERSION MODEL

(71) Applicant: Saudi Arabian Oil Company, Dhahran (SA)

(72) Inventors: Abdulaziz N. Ababtain, Dammam (SA); Arafat M. Aloqaily, Dhahran (SA)

(21) Appl. No.: 16/117,717

(22) Filed: Aug. 30, 2018

(51) Int. Cl. G06F 17/30

(52) U.S. Cl. CPC G06F 17/30241; G06Q 50/06

(57) ABSTRACT

A correlation relationship between a pipeline pumped-in Normal Flow Rate (NFR) value, a pipeline diameter and a pipeline pressure is determined. A matrix including values of pipeline flow rate, pipeline diameters and pipeline pressures is developed. The matrix is provided as an input to a dispersion model to obtain multiple ½ lower flammable limit (LFL) downwind distance. A pipeline Rupture Exposure Radius (RER) value is determined based on the obtained ½ LFL downwind distance, and the determined RER value is expressed as a function of the pipeline diameter and the pipeline pressure.

### TECHNICAL FIELD

This specification relates to determining pipeline Rupture Exposure Radius (RER) in a case of pipeline failure.

### BACKGROUND

Pipeline design is dependent on the Rupture Exposure Radius (RER) value. According to safety standards, number of buildings located inside the pipeline RER will affect the pipeline classification, which in turn determines the designed pipeline wall thickness and the number of emergency isolation valves, and sectionalizing valves spam that are required to be present along the pipeline route.

### SUMMARY

The present disclosure describes technologies related to determining an accurate pipeline RER value for hydrocarbon flammable clouds dispersion in case of a pipeline failure. For sweet gas pipelines, the RER value can be determined by estimating the ½ lower flammable limit (LFL) extend of the released vapor cloud. In some aspects, hydrocarbon modelling software, for example, the PHASTTM software by DNV GL AS (“DNV PHAST”) or the FRED software model by Shell (“Shell FRED”), can be used to model several scenarios of pipelines rupture.

An example implementation of the subject matter described within this disclosure has with the following features. A correlation relationship between a pipeline's pumped-in Normal Flow Rate (NFR) value, a pipeline diameter and a pipeline pressure is determined. The pipeline NFR values, the pipeline diameter and the pipeline pressure are associated with a pipeline transporting hydrocarbons from one location to another. A matrix including multiple values of pipeline flow rates, pipeline diameters and pipeline pressures is developed. The matrix includes combinations of the pipeline flow rate, the pipeline diameter, and the pipeline pressure, and each of the pipeline flow rate can be determined based on the pipeline NFR value. Each pipeline flow rate value corresponds to a flow rate at which a pipeline having a pipeline diameter flowing hydrocarbons at a pipeline pressure ruptured. The matrix is provided as an input to a dispersion model to obtain multiple ½ lower flammable limit (LFL) downwind distances. A ½ LFL downwind distance represents a distance by which the hydrocarbons disperse from a ruptured pipeline. A pipeline Rupture Exposure Radius (RER) value is determined based on the obtained ½ LFL downwind distances. The RER value is defined by modelling a downwind dispersion distance at a ground level in case of a pipeline full bore rupture to a limit of ½ LFL downwind distance of released vapor. The determined pipeline RER value is expressed as a function of the pipeline diameter and the pipeline pressure.

Aspects of the example implementation combinable with any of the other aspects can include the following features. The correlation relationship is determined on a 95% confidence interval based on a regression analysis. The pipeline flow rate is 5 times the pipeline NFR value.

Aspects of the example implementation combinable with any of the other aspects can include the following features include the following. Determining a correlation relationship between a pipeline NFR value and a pipeline diameter and a pipeline pressure includes determining a correlation relationship between a pipeline diameter and a pipeline NFR value. A correlation relationship between the pipeline NFR value, the pipeline diameter, and a pipeline pressure can be determined. The pipeline NFR value is expressed as a square root of the pipeline pressure multiplied by the pipeline diameter squared.

Aspects of the example implementation combinable with any of the other aspects can include the following features include the following. The pipeline NFR value is determined based on:

NFR=0.006×D²×\sqrt{P},

where D is the pipeline diameter and P is the pipeline pressure.

Aspects of the example implementation combinable with any of the other aspects can include the following features include the following. The pipeline RER value is determined based on:

RER=20×(D²×\sqrt{P})^{0.3},

where D is the pipeline diameter and P is the pipeline pressure.

Aspects of the example implementation combinable with any of the other aspects can include the following features include the following. Modeling the matrix by a dispersion model includes receiving multiple predetermined operating parameters associated with a pipeline failure analysis. The matrix is modelled by a dispersion model based on the received multiple operating parameters to generate a modeling result. The modeling result is normalized into a graphical model representing a formula that expresses the pipeline flow rate as a function of the pipeline diameter and the pipeline pressure.

Another example implementation is a method that includes the following features. For a pipeline through which hydrocarbons can flow, a correlation relationship between a pipeline pumped-in Normal Flow Rate (NFR) value, a pipeline diameter and a pipeline pressure is determined. A matrix including multiple pipeline flow rate values, multiple diameters and multiple pressures is developed. Each pipeline flow rate value corresponds to a flow rate at which a pipeline having a pipeline diameter flowing hydrocarbons at a pipeline pressure ruptured. The matrix is provided as an input to a dispersion model to obtain an output that includes a ½ lower flammable limit (LFL) downwind distance matrix including multiple LFL distances, each representing a distance by which the hydrocarbons disperse from a ruptured pipeline. The ½ LFL downwind distance matrix further includes multiple pipeline diameters and multiple pipeline pressures, each diameter and pressure associated with a respective LFL distance. From the ½ LFL downwind distance matrix, a pipeline Rupture Exposure Radius (RER) model that relates a rupture distance to the pipeline diameter and the pipeline pressure is determined.

Aspects of the example implementation combinable with any of the other aspects can include the following features include the following. The correlation relationship is determined on a 95% confidence interval based on a regression analysis. The pipeline flow rate is 5 times the pipeline NFR value.

Aspects of the example implementation combinable with any of the other aspects can include the following features include the following. Determining a correlation relationship between a pipeline NFR value and a pipeline diameter and a pipeline pressure includes determining a correlation relationship between a pipeline diameter and a pipeline NFR value. A correlation relationship between the pipeline NFR value, the pipeline diameter, and a pipeline pressure can be determined. The pipeline NFR value is expressed as a square root of the pipeline pressure multiplied by the pipeline diameter squared.

Aspects of the example implementation combinable with any of the other aspects can include the following features include the following. The pipeline NFR value is determined based on:

NFR=0.006×D²×\sqrt{P},

where D is the pipeline diameter and P is the pipeline pressure.

Aspects of the example implementation combinable with any of the other aspects can include the following features include the following. The pipeline RER value is determined based on:

RER=20×(D²×\sqrt{P})^{0.3},

where D is the pipeline diameter and P is the pipeline pressure.

Aspects of the example implementation combinable with any of the other aspects can include the following features include the following. Modeling the matrix by a dispersion model include receiving multiple predetermined operating parameters associated with a pipeline failure analysis. The matrix is modelled by a dispersion model based on the received multiple operating parameters to generate a modeling result. The modeling result is normalized into a graphical model representing a formula that expresses the pipeline flow rate as a function of the pipeline diameter and the pipeline pressure.

The details of one or more implementations of the subject matter described in this specification are set forth in the accompanying drawings and the description later. Other features, aspects, and advantages of the subject matter will become apparent from the description, the drawings, and the claims.

### BRIEF DESCRIPTION OF THE DRAWINGS

FIG. 1 is a flow chart that illustrates an example method for determining a RER value based on a dispersion model, according to some implementations.

FIG. 2 is a graph that illustrates the change of pipeline flow rate over time when a pipeline failure occurred, according to some implementations.

FIG. 3A is a graph that illustrates the dispersion analysis result generated by the DNV PHAST software packages, according to some implementations.

FIG. 3B is a graph that illustrates the dispersion analysis result generated by the Shell FRED software packages, according to some implementations.

FIG. 4 is a graph that illustrates a model created using SPS Stoner Pipeline Simulator hydraulic modelling software, according to some implementations.

FIG. 5A is a graph that illustrates a comparison between the RER distance prediction determined by the resulted equation and the exact RER value obtained by PHAST, according to some implementations.

FIG. 5B is a graph that illustrates the comparison between the RER distance prediction determined by the resulted equation and the exact RER value obtained by PHAST as plotted in regression lines, according to some implementations.

FIG. 6 is a block diagram illustrating an example of a computer-implemented System used to provide computational functionalities associated with described algorithms, methods, functions, processes, flows, and procedures, according to some implementations.

Like reference numbers and designations in the various drawings indicate like elements.

### DETAILED DESCRIPTION

The present disclosure describes determining a Rupture Exposure Radius (RER) value based on a dispersion model. For example, in some aspects, a normalized representative number of dispersion modeling cases are utilized through available commercial software packages to develop an empirical model to efficiently determine the pipeline classification based on a RER value, reducing the thickness of the designed pipeline wall, and the number of emergency isolation valves required to present along the pipeline route.

Gas pipelines are classified based on the population existing inside the RER zone along the pipeline route. The classification will determine the design factor; hence, the percentage of the pipe rated strength, which is the Specified Minimum Yield Stress (SMYS) that could be reached during operations. Moreover, this classification will determine the number of sectionalizing and emergency isolation valves required along the pipeline. As an example illustrated in Table 1, the higher the class, the shorter the distance required for valve spacing. As a result, pipeline class will have major impact in its capital cost. The pipeline classification can be directly affected by the RER value. For example, certain pipeline safety standard determines the pipeline classification by dividing the pipeline into segments and counting the dwellings located in these segments. The counted number is identified as the pipeline density index (PDI). The zones inside these segments are one-kilometer long and 2 times the pipeline RER value wide. The pipeline class then can be selected based on the population density index determination.

TABLE 1
Gas Pipeline Sectionalizing Valves Spacing

| Location Class | Valve Spacing |
|---|---|
| 1 | 32 km |
| 2 | 24 km |
| 3 | 16 km |
| 4 | 8 km |

Currently, for example, certain pipelines safety standards set default RER values to be used in the pipeline design based on conservative estimates of downwind gas cloud extent. This conservative value has a great impact on both the capital cost and land utilization of the pipeline construction, especially for designing pipelines that carry sweet gases which are known to have lower RER values than mandated by certain safety standards. For example, lower RER distances result in more flexibility in route selection, lower pipeline location class and hence thinner pipeline wall, less emergency isolation valves required and longer span between sectionalizing valves resulting a high amount of savings. As sweet gas pipeline systems are hugely expanding, an efficient way of calculating RER will be highly beneficial and cost effective for the pipeline design projects.

The standard also permits RER to be defined by modeling the downwind dispersion distance at ground level in case of a pipeline full bore rupture to the limit of 100 ppm of H₂S or ½ the lower flammable limit (LFL) of the released vapor, whichever is greater. The ½ LFL downwind distance represents a distance by which the hydrocarbons disperse from a ruptured pipeline. Dispersion distances calculated by these approaches are much smaller than tabulated standardized values.

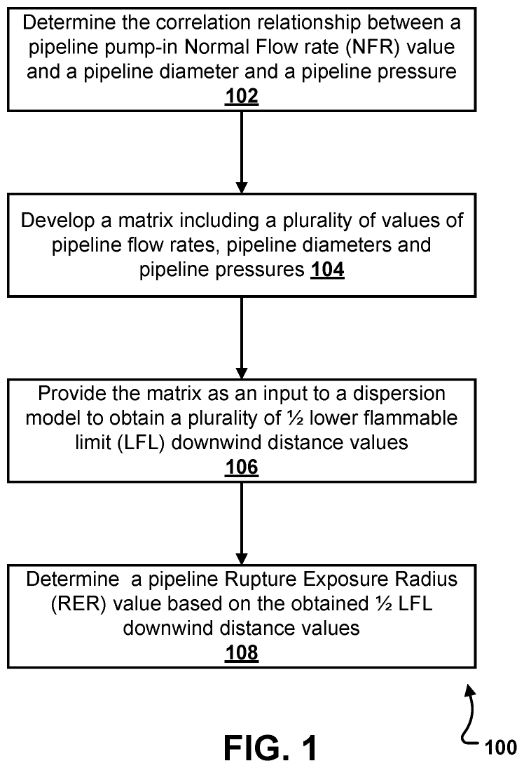

FIG. 1 is a flow chart that illustrates an example method 100 for determining a RER value based on a dispersion model, according to some implementations. In some implementations, the example method 100 can be implemented by one or more computer. For clarity of presentation, the description that follows generally describes method 100 in the context of the other figures in this description.

At 102, the correlation relationship between a pipeline pumped-in Normal Flow rate (NFR) value and a pipeline diameter and a pipeline pressure is determined. The pipeline NFR value is the pumped in flow rate under normal operation. The pipeline diameter and the pipeline pressure values are obtained from real pipelines data. In this case, 62 pipeline data are used to find the correlations, and 117 modeling cases combinations are created using the correlations.

In some implementations, these pipeline network parameters, that is the NFR value, the pipeline diameter and the pipeline pressure, are used in a regression analysis on a 95% confidence interval to determine whether there are any relations between them. Some commercial available software, such as the Microsoft® Excel add-in can be used in this step. The result shows a correlation with the square root of the pressure multiplied by the parameter squared. In some implementations, it is concluded that these three parameters are interlinked and could be expressed as a function as shown in Eq. 1.

NFR=0.006*D²*p^{0.5} (1)

In Eq. 1, NFR is the pipeline NFR value in kg/s. Note, because the correlation is empirical and based on the used units, it should not be considered as a scientific formula as the conversion will play a role in the constant used.

Once the correlation relationship is determined, at 104, a matrix is developed. The developed matrix includes multiple values of pipeline flow rates, pipeline diameters and pipeline pressures, and the multiple pipeline flow rate, the pipeline diameter, and the pipeline pressure from various combinations. Each of the pipeline flow rate can be determined based on the pipeline NFR value.

The pipeline flow rate is used to represent the effective release rate of the hydrocarbon vapors from a ruptured pipeline flowing hydrocarbons. In some implementation, the pipeline flow rate can be represented by five times the NFR value. To develop the matrix, the NFR value for each Diameter-Pressure pair is calculated, and then the NFR value is multiplied by 5 and used as a pipeline flow rate value corresponding to each Diameter-Pressure pair. Based on the research, it is concluded that for high-pressure, large-diameter pipelines (for example, the pressure is five times the NFR value, and the diameter is larger than 24 inches), five times the NFR value is an under-prediction of the effective release rate, while for low-pressure, small-diameter pipelines (for example, the pressure is three times the NFR value, and the diameter is smaller than 24 inches), five times the NFR is an over-prediction of the effective release rate. However, on average, 5 times the NFR is sometimes agreed to provide a good estimate of the results.

At 106, the matrix is provided as an input to a dispersion model to obtain multiple ½ lower flammable limit (LFL) downwind distance values. The ½ LFL downwind distance represents a distance by which the hydrocarbons disperse from a ruptured pipeline to ½ of the minimum concentration at which the gas mixture at air could ignite or be flammable.

The dispersion model can be a commercially available dispersion model software that is capable of representing the extent of the flammable vapor clouds beginning with their release from the pipeline until they disperse. For example, it is required by some safety standards to trace the cloud's flammable components for sweet gas pipeline until its concentration reaches ½ LFL at ground level or 1 m height, that is, the end point of lethal flammable concentration. In some implementations, a gas dispersion software package, for example, DNV PHAST or Shell FRED can be used to simulate the dispersion.

The inputs of this dispersion model include the matrix developed at 104, as well as several other parameters associated with the simulation. For example, some safety standards may set default parameters for release duration, sweet gas composition, meteorological conditions, weather conditions, etc. Several sensitivity cases on the input parameter can also be evaluated to assure achieving conservative results.

In some implementations, after inputting the matrix and other parameters into the dispersion model, an output that includes a ½ LFL downwind distance matrix include multiple LFL distances can be obtained. The ½ LFL downwind distance matrix further includes multiple pipeline diameters and multiple of pipeline pressures, each diameter and pressure associated with a respective LFL distance.

At 108, a pipeline Rupture Exposure Radius (RER) value is determined based on the obtained ½ LFL downwind distance. The RER value is defined by modelling a downwind dispersion distance at ground level in case of a pipeline full bore rupture to a limit of ½ LFL downwind distance of the released vapor. In some implementations, the determined pipeline RER value can be expressed as a function of the pipeline diameter and the pipeline pressure, as shown in Eq. 2:

RER=20*(D²*\sqrt{P})^{0.3} (2)

Where RER is the rupture exposure radius in meter, D is the diameter in inch, and P is the pressure in psig.

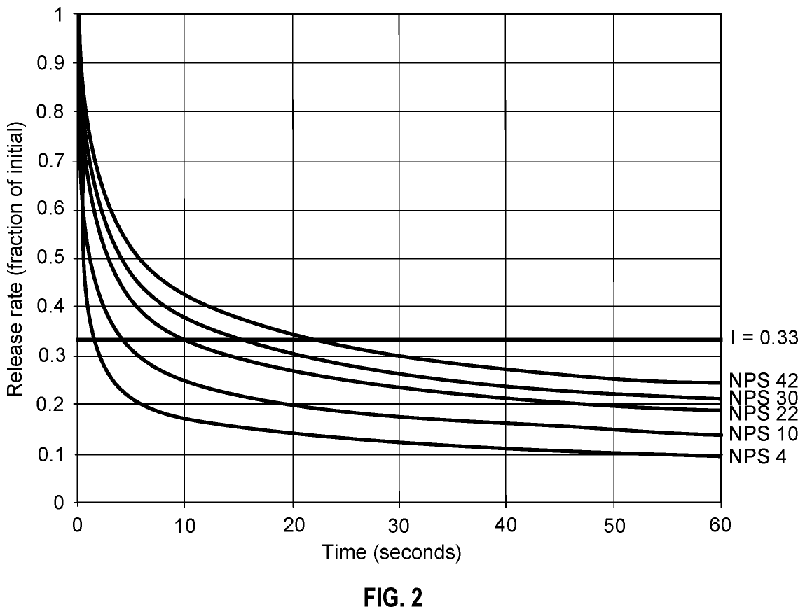

FIG. 2 is a graph that illustrates the change of pipeline flow rate over time when a pipeline failure occurred, according to some implementations. For the graph shown in FIG. 2, the x-axis is time in seconds (s), and the y-axis is the pipeline flow rate (fraction of initial). When a full-bore rupture failure happened, gas will release with spike high pipeline flow rate due to relatively very low atmospheric pressure and the release that comes from both the sides (that is, the upstream and the downstream) of the pipeline's rupture location. Within seconds, the flow rate will decrease until it reaches a steady state value. To determine the flow rate, the initial release rate during initial gas discharge is first determined by software. The initial peak rate will last for few seconds only and can be estimated using the equation for sonic or choked flow through an orifice. As it only lasts for few seconds, the determined peak rate is multiplied by a parameter representing the decay in the rate (A) to have a representative rate for the release duration. The value of λ depends on the size of modelled pipeline, the pressure in the line at the time of failure and the conveyed fluid. λ usually ranges from 0.2-0.5. A value of 0.33 is accepted in the industry for sweet gas as a representative yet conservative value.

For example, certain guidelines suggest the use of value of 0.25 or using a pipeline flow rate that equals to 5 times the pumped-in Normal Flow Rate (NFR) conveyed by pipeline operating up to 800 psig as a conservative cap to account for uncertainties of the release rate. Utilizing three times NFR as a flow rate cap gives reasonably conservative, yet representative values for almost all of sweet gas network actual cases specially those close to 800 psig, the only exception is small pipelines with low pressure low flow operation as those flows will be overestimated, however, will not affect the dispersion results significantly.

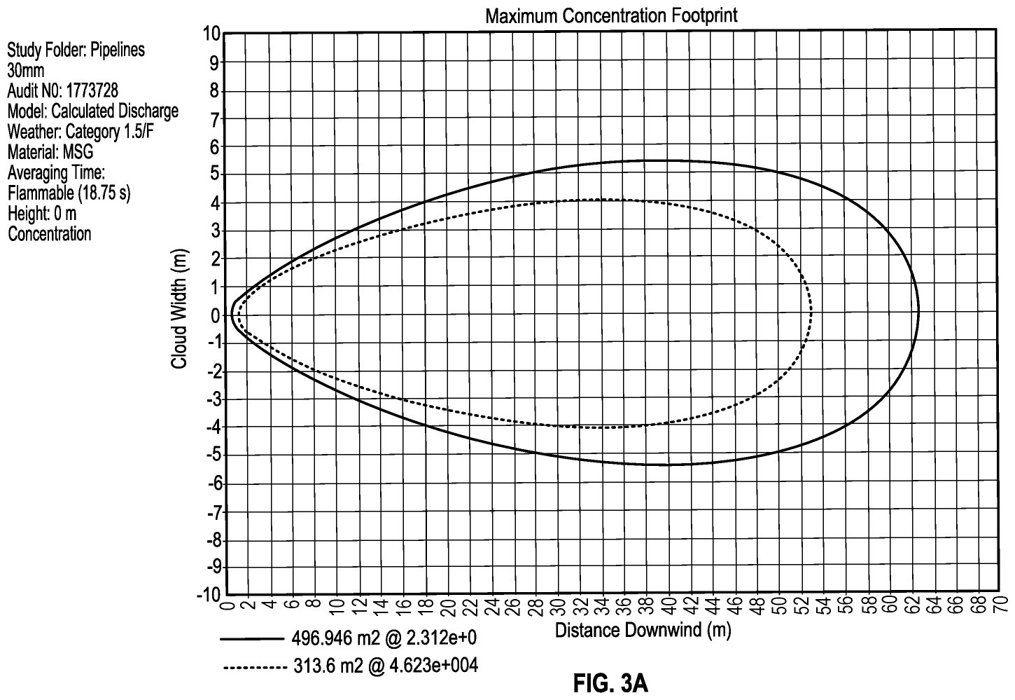

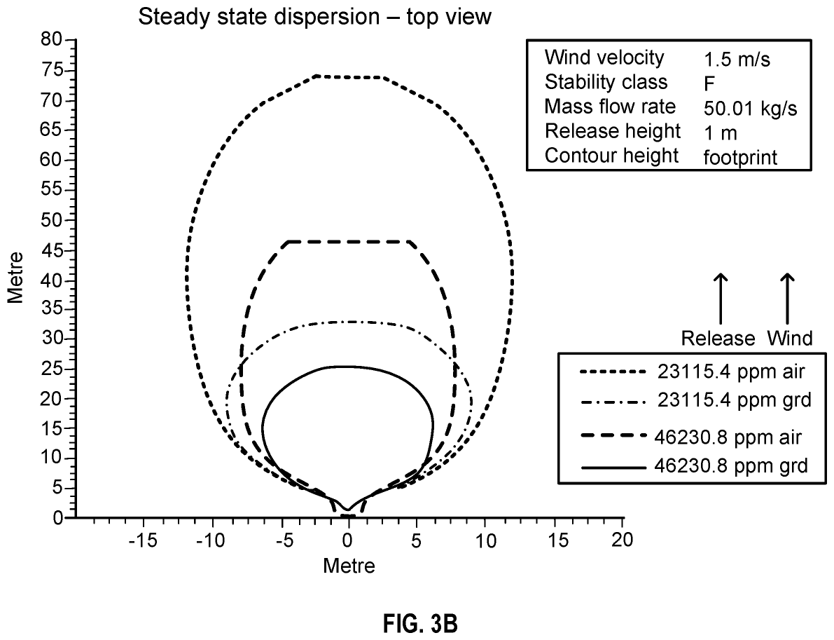

FIGS. 3A-3B are graphs that illustrate the dispersion analysis result generated by the software packages, according to some implementations. Consequence modelling software that analyze and calculate the dispersion can be used in dispersion analysis. Currently, two commercial packages are used, that is, DNV PHAST and Shell FRED. Both software packages have been used for a sample calculation and almost matching results were observed, as the sample results shown in FIGS. 3A-3B, where FIG. 3A shows a sample result for the DNV PHAST, and FIG. 3B shows a sample result for Shell FRED. Only minor dissimilarities in meters are observed which is caused by the difference in each software definition of the input composition ½ LFL content and in its built-in reporting options of maximum concentration, heights.

The capabilities of the selected models are almost the same especially when tracing flammable gas clouds. The majority of the models summarized above require the user to analyze the release quantity and rate or at least guide its calculations as an input to the model. Although they are similar, the two software have some differences, as shown in FIGS. 3A and 3B, and pros and cons of these two software are illustrated as the following:

DNV PHAST:
Very detailed and complex input required for the main model.
Sophisticated not user friendly interface that could easily allow mistakes.
Capable to add high numbers of cases for the same model easily.
Various number of results are easily extractable to the desired form.

Shell FRED:
Simplified input required for the main model.
User friendly interface with interactive icons.
Not capable to add high numbers of cases for the same model easily.
Results are harder to extract to the desired form.

### Experiment

Based on the previous descriptions, an experiment is conducted to determine RER value based on a dispersion model, and the experiment result is evaluated.

First, for the purpose of selecting the pipeline flow rate calculation method that represents a full bore rupture of a pipeline, three main approaches were compared:
Certain: utilizing a decay factor of 0.25 with a cap of 3*Normal Flow Rate for pipelines operating up to 800 psig.
PHMSA/ASME: utilizing a decay factor of 0.33.
PHAST: utilizing generated flow rates for an average time of 900 s.

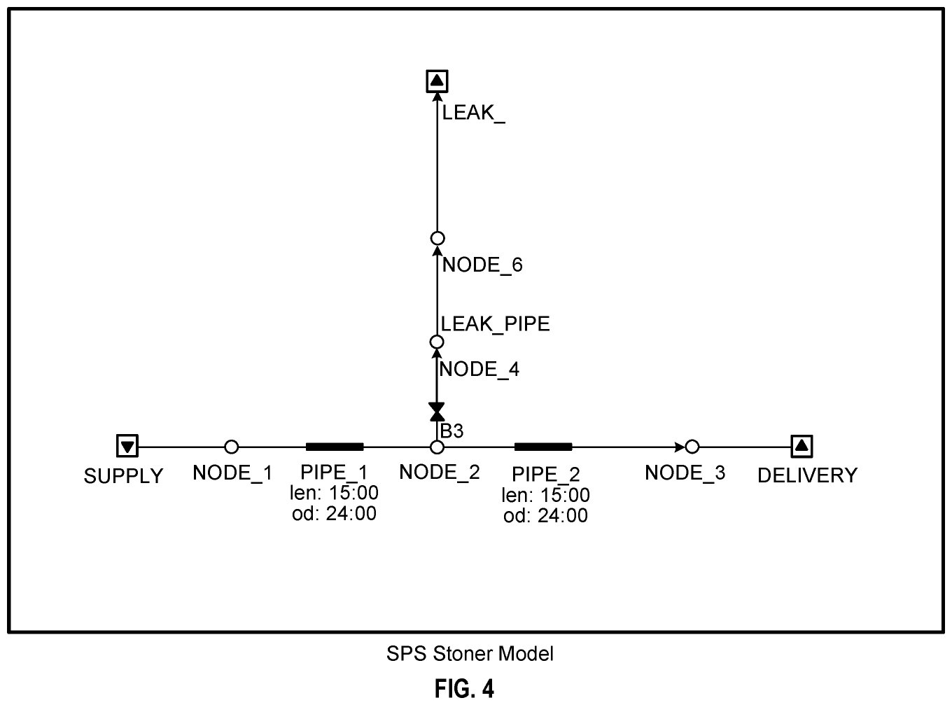

A simple model, as in FIG. 4 ,was created using SPS Stoner Pipeline Simulator hydraulic modelling software package with different lengths of pipes taken 30 km as a base case and a release point to atmosphere in the middle of the pipeline. The simulation considered 3 different pipeline sizes i.e., 56″, 24″ & 10″ along with 3 different combinations of pressures and flow rates that had been correlated earlier. The results were extracted considering constant flow rate during a full-bore rupture without isolation. Results from these three approaches are compared as shown in Table 2.

A decay factor (λ) equals to 0.33 as suggested by U.S. DOT Pipeline and Hazardous Materials Safety Administration (PHMSA) report used in ASME B31.8s Potential Impact Radius calculations. This had resulted in flow rates ranges of 2-3.6 times the NFR for more than 70% of the Certain network.

Another approach using PHAST to generate flow rate for the average time of 900 s resulted in flow rates of 2-4.2 times the NFR for more than 80% of the Certain pipeline network which also supports the Certain approach that was used in the development of the modelled matrix. However, with high flow high pressure pipelines accounted in the modelled matrix the release flow will exceed the predicted flow rate by the developed correlation.

The results show that certain rule of thumb for utilizing 5 times NFR as a flow rate cap gave reasonably conservative yet representative values for almost all of sweet gas network actual cases especially those operating close to 800 psig, the only exception is small pipelines with low pressure low flow operations as those flows will be overestimated. In this experiment, the certain approach was considered in the development of the modelling matrix.

TABLE 2
Pipeline flow rate Approaches Results Comparison

| | PHMSA | Aramco | PHAST |
|---|---|---|---|
| Case | (fract. of IR*) | (fract. of IR*) | (fract. of IR*) |
| Large | 0.33 | 0.25-0.33 | 0.35 |
| Large | 0.33 | 0.33 | 0.355 |
| Large | 0.33 | 0.25-0.45 | 0.37 |
| Medium | 0.33 | 0.25-0.36 | 0.4 |
| Medium | 0.33 | 0.25-0.5 | 0.44 |
| Small | 0.33 | 0.25-0.5 | 0.57 |
| Small | 0.33 | 0.25-0.7 | 0.6 |

*IR stands for the initial rate

In the dispersion analysis, the matrix parameter ranges used are listed in Table 3 that sets the applicable range for the RER determination model. In this case, the flow rate matrix is generated based on 117 real pipeline cases and includes various combinations of the flow rate, the pipeline diameter, and pipeline pressure, as shown in Table 4.

TABLE 3
Operating Parameter Range Used in Modelled Matrix

| | | |
|---|---|---|
| Parameter | Applicable Range | Range Steps |

| | | | |
|---|---|---|---|
| Pressure | 300-2,200 | psig | 200 psig |
| Flow Rate | 7-4,300 | MMSCFD* | Correlated as Eq. 1 |

| | | |
|---|---|---|
| Diameter | 4″-60″ | 5″ |
| Composition | Mainly Methane | N/A |

*MMSCDF stands for the Million Standard Cubic Feet per Day

TABLE 4
Modeling Matrix for Dispersion Model
Correlated Representative Release Rate * Kg/s

| Pressure | Diameter (in) | | | | | | | | | | | | |
|---|---|---|---|---|---|---|---|---|---|---|---|---|---|
| (psig) | 4 | 6 | 10 | 15 | 20 | 25 | 30 | 35 | 40 | 45 | 50 | 55 | 60 |
| 300 | 5 | 11 | 31 | 70 | 125 | 195 | 281 | 382 | 499 | 631 | 779 | 943 | 1122 |
| 500 | 6 | 14 | 40 | 91 | 161 | 252 | 362 | 493 | 644 | 815 | 1006 | 1218 | 1449 |
| 800 | 8 | 18 | 51 | 115 | 204 | 318 | 458 | 624 | 815 | 1031 | 1273 | 1540 | 1833 |
| 1000 | 9 | 20 | 57 | 128 | 228 | 356 | 512 | 697 | 911 | 1153 | 1423 | 1722 | 2049 |
| 1300 | 10 | 23 | 65 | 146 | 260 | 406 | 584 | 795 | 1038 | 1314 | 1622 | 1963 | 2336 |
| 1500 | 11 | 25 | 70 | 157 | 279 | 436 | 627 | 854 | 1115 | 1412 | 1743 | 2109 | 2510 |
| 1700 | 12 | 27 | 74 | 167 | 297 | 464 | 668 | 909 | 1187 | 1503 | 1855 | 2245 | 2672 |
| 2000 | 13 | 29 | 80 | 181 | 322 | 503 | 724 | 986 | 1288 | 1630 | 2012 | 2435 | 2898 |
| 2200 | 14 | 30 | 84 | 190 | 338 | 528 | 760 | 1034 | 1351 | 1710 | 2111 | 2554 | 3039 |

* Incorporating decay factor

The flow rates contained in the developed matrix developed from the 117 cases are input into the dispersion model and the results in terms of dispersion distances are extracted as in Table 5.

TABLE 5
Matrix Resulted Dispersion for 1.5 F. Weather
½ LFL Downwind Cloud Dispersion Distance (m)

| Pressure | Diameter (in) | | | | | | | | | | | | |
|---|---|---|---|---|---|---|---|---|---|---|---|---|---|
| (psig) | 4 | 6 | 10 | 15 | 20 | 25 | 30 | 35 | 40 | 45 | 50 | 55 | 60 |
| 300 | 52 | 77 | 117 | 156 | 189 | 216 | 242 | 266 | 287 | 307 | 329 | 346 | 361 |
| 500 | 59 | 86 | 128 | 169 | 203 | 235 | 262 | 287 | 309 | 333 | 352 | 373 | 396 |
| 800 | 66 | 95 | 139 | 183 | 220 | 249 | 281 | 305 | 333 | 354 | 379 | 402 | 420 |
| 1000 | 70 | 99 | 144 | 190 | 228 | 260 | 289 | 38 | 344 | 365 | 393 | 415 | 430 |
| 1300 | 75 | 105 | 152 | 198 | 237 | 272 | 298 | 331 | 355 | 383 | 408 | 427 | 452 |
| 1500 | 77 | 108 | 156 | 202 | 242 | 278 | 306 | 338 | 360 | 393 | 415 | 435 | 464 |
| 1700 | 79 | 110 | 159 | 205 | 245 | 282 | 313 | 343 | 369 | 400 | 422 | 446 | 474 |
| 2000 | 82 | 114 | 163 | 211 | 251 | 288 | 322 | 351 | 381 | 409 | 428 | 459 | 485 |
| 2200 | 83 | 116 | 166 | 214 | 255 | 292 | 327 | 354 | 387 | 414 | 435 | 467 | 492 |

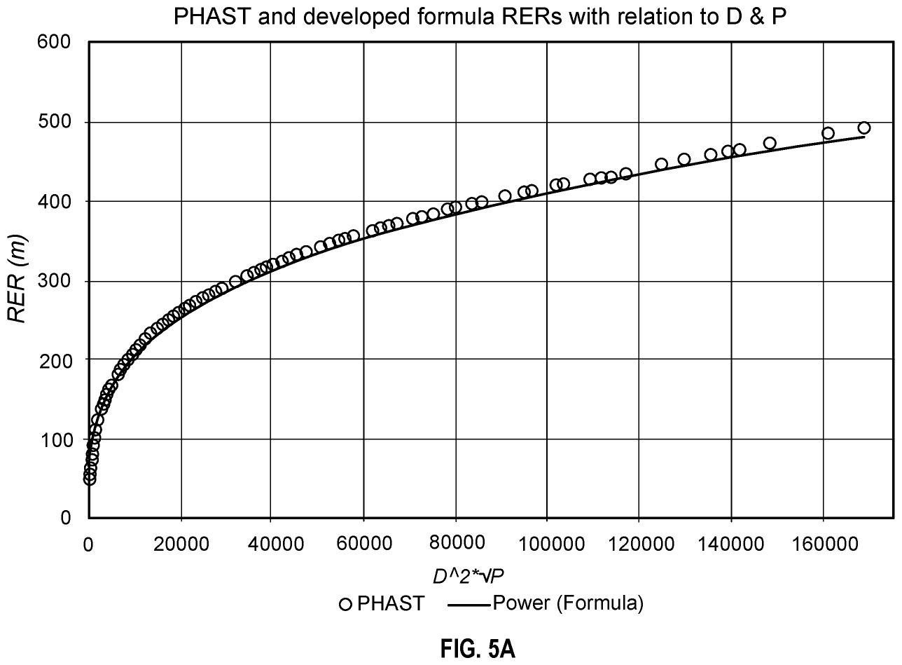

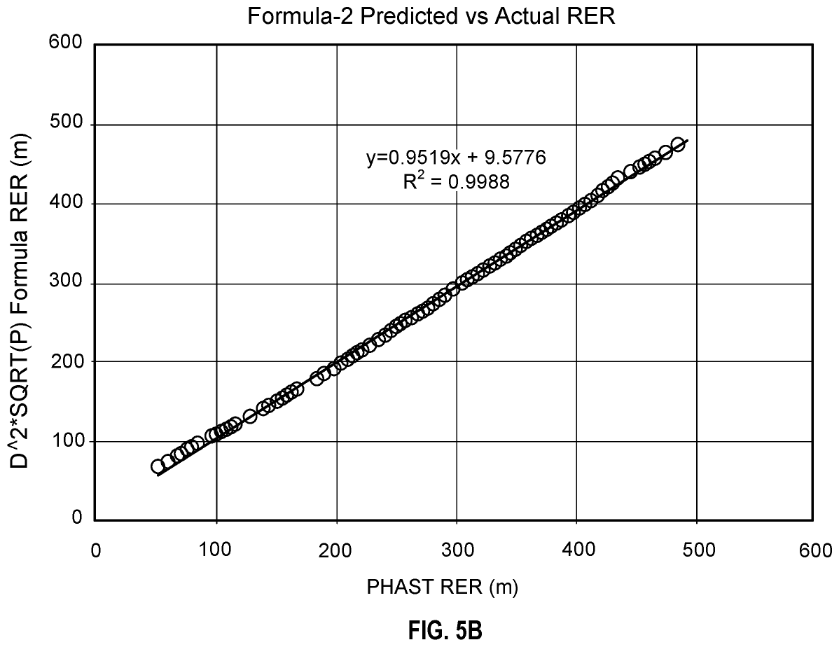

The results are plotted against flow rate, pressure, and diameter. Once plotted, the ½ LFL downwind distance produces a clear pattern that could be easily fitted in simple representative formulas. Resulted downwind dispersion data points when plotted against pipeline diameter and pressure correlated parameter, that is, D²*\sqrt{P} as shown in FIG. X, follow an exponential power trendline, as expected. From the plotting, a relationship equation such as Eq. 2 can also be derived. Further, as shown in FIG. 5A, the resulted formula has a small range of error (in this case, 4%) in its RER distance prediction compared with exact RER values obtained by PHAST. Moreover, the formula predicted vs. PHAST actual values are plotted and the regression line precisely estimates RERs as shown in FIG. 5B.

The experiment further shows that the developed method described in this disclosure results in a reduction of 86% of the RER distances with an average error of 4% in their prediction of DNV PHAST dispersion modeling results.

### Savings shown from an On-Site Study Based on the Developed Equation

The developed equation contributes to huge savings due to finding more accurate RER values. In one project where the equation is applied to an actual sweet gas pipeline network design, the equation had reduced an average of 1.3 km of RER length representing 86% of the sweet gas pipeline RER average value. Some pipelines even show a reduction of up to 89% of the RER length.

This can contribute to savings in terms of areas to be assessed for population, overestimating required area classifications and associated upgrade costs, reduction of High Consequence Areas, which is areas where consequences to people are expected to be high and require further attention in inspection and maintenance. HCAs, better repair prioritization and better utilization of resources. For example, assume a land of area of 24,000 km² is considered within the RER boundaries and is needed to be accessed during both pipeline design and periodic surveillance. While on the other hand, when the proposed method is used to calculate the RER, the average value covers an area of 3,800 km² which represent a reduction of 84% of areas within RER boundaries in lands. As a result, these areas can be excluded from consideration in the classification requirements that call for actual population count rather that density. Therefore, smaller area usually include less population.

In addition, as RER plays a huge role in pipeline classification, a huge capital cost saving could be achieved using the developed RER calculation method. This is mainly associated with allowing lower classes associated with thinner pipeline wall thickness, fewer emergency isolation valves required and longer span allowed between sectionalizing valves.

In one case study, where the pipeline diameter is 56″ and the pipeline pressure is 1200 psig, applying the calculation method results in an RER of 420 m instead of the default value of 2,000. Based on the new RER, original Population Density Index (PDI) that covers 228 km² area have been reassessed and resulted in a new PDI that covers 74 km² area. The reassessed PDI allowed the re-classification of 7 km long segment from class 4 to location class 2 eliminating the need for two 56″ remotely operated isolation valves and the use of thicker wall thickness line pipeline. It is estimated that the deployment of the new RER reduces the capital cost by $12 MM ($1.7 MM/km) which is approximately 14% of the project total capital cost. The potential savings the method influence is even higher if the pipeline runs into semi-urban or urban areas where longer segments could be affected.

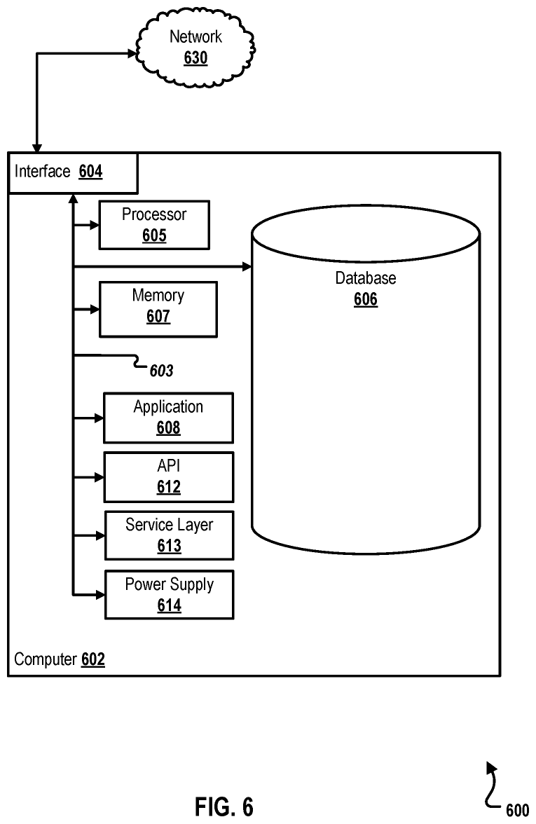

FIG. 6 is a block diagram illustrating an example of a computer-implemented System 600 used to provide computational functionalities associated with described algorithms, methods, functions, processes, flows, and procedures, according to an implementation of the present disclosure. In the illustrated implementation, System 600 includes a Computer 602 and a Network 630.

The illustrated Computer 602 is intended to encompass any computing device such as a server, desktop computer, laptop/notebook computer, wireless data port, smart phone, personal data assistant (PDA), tablet computer, one or more processors within these devices, another computing device, or a combination of computing devices, including physical or virtual instances of the computing device, or a combination of physical or virtual instances of the computing device. Additionally, the Computer 602 can include an input device, such as a keypad, keyboard, touch screen, another input device, or a combination of input devices that can accept user information, and an output device that conveys information associated with the operation of the Computer 602, including digital data, visual, audio, another type of information, or a combination of types of information, on a graphical-type user interface (UI) (or GUI) or other UI.

The Computer 602 can serve in a role in a distributed computing system as a client, network component, a server, a database or another persistency, another role, or a combination of roles for performing the subject matter described in the present disclosure. The illustrated Computer 602 is communicably coupled with a Network 630. In some implementations, one or more components of the Computer 602 can be configured to operate within an environment, including cloud-computing-based, local, global, another environment, or a combination of environments.

At a high level, the Computer 602 is an electronic computing device operable to receive, transmit, process, store, or manage data and information associated with the described subject matter. According to some implementations, the Computer 602 can also include or be communicably coupled with a server, including an application server, e-mail server, web server, caching server, streaming data server, another server, or a combination of servers.

The Computer 602 can receive requests over Network 630 (for example, from a client software application executing on another Computer 602) and respond to the received requests by processing the received requests using a software application or a combination of software applications. In addition, requests can also be sent to the Computer 602 from internal users (for example, from a command console or by another internal access method), external or third-parties, or other entities, individuals, systems, or computers.

Each of the components of the Computer 602 can communicate using a System Bus 603. In some implementations, any or all of the components of the Computer 602, including hardware, software, or a combination of hardware and software, can interface over the System Bus 603 using an application programming interface (API) 612, a Service Layer 613, or a combination of the API 612 and Service Layer 613. The API 612 can include specifications for routines, data structures, and object classes. The API 612 can be either computer-language independent or dependent and refer to a complete interface, a single function, or even a set of APIs. The Service Layer 613 provides software services to the Computer 602 or other components (whether illustrated or not) that are communicably coupled to the Computer 602. The functionality of the Computer 602 can be accessible for all service consumers using the Service Layer 613. Software services, such as those provided by the Service Layer 613, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the Computer 602, alternative implementations can illustrate the API 612 or the Service Layer 613 as stand-alone components in relation to other components of the Computer 602 or other components (whether illustrated or not) that are communicably coupled to the Computer 602. Moreover, any or all parts of the API 612 or the Service Layer 613 can be implemented as a child or a sub-module of another software module, enterprise application, or hardware module without departing from the scope of the present disclosure.

The Computer 602 includes an Interface 604. Although illustrated as a single Interface 604, two or more Interfaces 604 can be used according to particular needs, desires, or particular implementations of the Computer 602. The Interface 604 is used by the Computer 602 for communicating with another computing system (whether illustrated or not) that is communicatively linked to the Network 630 in a distributed environment. Generally, the Interface 604 is operable to communicate with the Network 630 and includes logic encoded in software, hardware, or a combination of software and hardware. More specifically, the Interface 604 can include software supporting one or more communication protocols associated with communications such that the Network 630 or hardware of Interface 604 is operable to communicate physical signals within and outside of the illustrated Computer 602.

The Computer 602 includes a Processor 605. Although illustrated as a single Processor 605, two or more Processors 605 can be used according to particular needs, desires, or particular implementations of the Computer 602. Generally, the Processor 605 executes instructions and manipulates data to perform the operations of the Computer 602 and any algorithms, methods, functions, processes, flows, and procedures as described in the present disclosure.

The Computer 602 also includes a Database 606 that can hold data for the Computer 602, another component communicatively linked to the Network 630 (whether illustrated or not), or a combination of the Computer 602 and another component. For example, Database 606 can be an in-memory, conventional, or another type of database storing data consistent with the present disclosure. In some implementations, Database 606 can be a combination of two or more different database types (for example, a hybrid in-memory and conventional database) according to particular needs, desires, or particular implementations of the Computer 602 and the described functionality. Although illustrated as a single Database 606, two or more databases of similar or differing types can be used according to particular needs, desires, or particular implementations of the Computer 602 and the described functionality. While Database 606 is illustrated as an integral component of the Computer 602, in alternative implementations, Database 606 can be external to the Computer 602.

The Computer 602 also includes a Memory 607 that can hold data for the Computer 602, another component or components communicatively linked to the Network 630 (whether illustrated or not), or a combination of the Computer 602 and another component. Memory 607 can store any data consistent with the present disclosure. In some implementations, Memory 607 can be a combination of two or more different types of memory (for example, a combination of semiconductor and magnetic storage) according to particular needs, desires, or particular implementations of the Computer 602 and the described functionality. Although illustrated as a single Memory 607, two or more Memories 607 or similar or differing types can be used according to particular needs, desires, or particular implementations of the Computer 602 and the described functionality. While Memory 607 is illustrated as an integral component of the Computer 602, in alternative implementations, Memory 607 can be external to the Computer 602.

The Application 608 is an algorithmic software engine providing functionality according to particular needs, desires, or particular implementations of the Computer 602, particularly with respect to functionality described in the present disclosure. For example, Application 608 can serve as one or more components, modules, or applications. Further, although illustrated as a single Application 608, the Application 608 can be implemented as multiple Applications 608 on the Computer 602. In addition, although illustrated as integral to the Computer 602, in alternative implementations, the Application 608 can be external to the Computer 602.

The Computer 602 can also include a Power Supply 614. The Power Supply 614 can include a rechargeable or non-rechargeable battery that can be configured to be either user- or non-user-replaceable. In some implementations, the Power Supply 614 can include power-conversion or management circuits (including recharging, standby, or another power management functionality). In some implementations, the Power Supply 614 can include a power plug to allow the Computer 602 to be plugged into a wall socket or another power source to, for example, power the Computer 602 or recharge a rechargeable battery.

There can be any number of Computers 602 associated with, or external to, a computer system containing Computer 602, each Computer 602 communicating over Network 630. Further, the term “client,” “user,” or other appropriate terminology can be used interchangeably, as appropriate, without departing from the scope of the present disclosure. Moreover, the present disclosure contemplates that many users can use one Computer 602, or that one user can use multiple computers 602.

What is claimed is:

1. A computer-implemented method, comprising:
determining a correlation relationship between a pipeline pumped-in Normal Flow Rate (NFR) value, a pipeline diameter and a pipeline pressure, wherein the pipeline NFR values, the pipeline diameter and the pipeline pressure are associated with a pipeline transporting hydrocarbons from one location to another;
developing a matrix including a plurality of values of pipeline flow rates, pipeline diameters and pipeline pressures, wherein the matrix comprises a plurality of combinations of the pipeline flow rate, the pipeline diameter, and the pipeline pressure, wherein each of the pipeline flow rate can be determined based on the pipeline NFR value, and wherein each pipeline flow rate value corresponds to a flow rate at which a pipeline having a pipeline diameter flowing hydrocarbons at a pipeline pressure ruptured;
providing the matrix as an input to a dispersion model to obtain a plurality of ½ lower flammable limit (LFL) downwind distance, wherein the ½ LFL downwind distance represents a distance by which the hydrocarbons disperse from a ruptured pipeline; and
determining a pipeline Rupture Exposure Radius (RER) value based on the obtained ½ LFL downwind distance, wherein the RER value is defined by modelling a downwind dispersion distance at a ground level in case of a pipeline full bore rupture to a limit of ½ LFL downwind distance of released vapor, and wherein the determined pipeline RER value is expressed as a function of the pipeline diameter and the pipeline pressure.

2. The computer-implemented method of claim 1, wherein the correlation relationship is determined on a 95% confidence interval based on a regression analysis.

3. The computer-implemented method of claim 1, wherein the pipeline flow rate is 5 times the pipeline NFR value.

4. The computer-implemented method of claim 1, wherein determining a correlation relationship between a pipeline NFR value and a pipeline diameter and a pipeline pressure comprises:
determining a correlation relationship between a pipeline diameter and a pipeline NFR value; and
determining a correlation relationship between the pipeline NFR value, the pipeline diameter, and a pipeline pressure, wherein the pipeline NFR value is expressed as a square root of the pipeline pressure multiplied by the pipeline diameter squared.

5. The computer-implemented method of claim 1, wherein the pipeline NFR value is determined based on NFR=0.006×D²×\sqrt{P}, wherein D is the pipeline diameter and P is the pipeline pressure.

6. The computer-implemented method of claim 1, wherein the pipeline RER value is determined based on RER=20×(D²\sqrt{P})^{0.3}, wherein D is the pipeline diameter and P is the pipeline pressure.

7. The computer-implemented method of claim 1,wherein modeling the matrix by a dispersion model comprises:
receiving a plurality of predetermined operating parameters, wherein the plurality of predetermined operating parameters are associated with a pipeline failure analysis;
modeling the matrix by a dispersion model based on the received plurality of operating parameters to generate a modeling result; and
normalizing the modeling result into a graphical model representing a formula that expresses the pipeline flow rate as a function of the pipeline diameter and the pipeline pressure.

8. A computer-implemented method comprising:
for a pipeline through which hydrocarbons are configured to flow, determining a correlation relationship between a pipeline pumped-in Normal Flow Rate (NFR) value, a pipeline diameter and a pipeline pressure;
developing a matrix including a plurality of pipeline flow rate values, a plurality of diameters and a plurality of pressures, wherein each pipeline flow rate value corresponds to a flow rate at which a pipeline having a pipeline diameter flowing hydrocarbons at a pipeline pressure ruptured;
providing the matrix as an input to a dispersion model to obtain an output comprising a ½ lower flammable limit (LFL) downwind distance matrix comprising a plurality of LFL distances, each representing a distance by which the hydrocarbons disperse from a ruptured pipeline, wherein the ½ LFL downwind distance matrix further comprising a plurality of pipeline diameters and a plurality of pipeline pressures, each diameter and pressure associated with a respective LFL distance; and
determining, from the ½ LFL downwind distance matrix, a pipeline Rupture Exposure Radius (RER) model that relates a rupture distance to the pipeline diameter and the pipeline pressure.

9. The computer-implemented method of claim 8, wherein the correlation relationship is determined on a 95% confidence interval based on a regression analysis.

10. The computer-implemented method of claim 8, wherein the pipeline flow rate is 5 times the pipeline NFR value.

11. The computer-implemented method of claim 8, wherein determining a correlation relationship between a pipeline NFR value and a pipeline diameter and a pipeline pressure comprises:
determining a correlation relationship between a pipeline diameter and a pipeline NFR value; and
determining a correlation relationship between the pipeline NFR value, the pipeline diameter, and a pipeline pressure, wherein the pipeline NFR value is expressed as a square root of the pipeline pressure multiplied by the pipeline diameter squared.

12. The computer-implemented method of claim 8, wherein the pipeline NFR value is determined based on NFR=0.006×D²×\sqrt{P}, wherein D is the pipeline diameter and P is the pipeline pressure.

13. The computer-implemented method of claim 8, wherein the pipeline RER model is determined based on RER=20×(D²×\sqrt{P})^{0.3}, wherein D is the pipeline diameter and P is the pipeline pressure.

14. The computer-implemented method of claim 8,wherein modeling the matrix by a dispersion model comprises:
receiving a plurality of predetermined operating parameters, wherein the plurality of predetermined operating parameters are associated with a pipeline failure analysis;
modeling the matrix by a dispersion model based on the received plurality of operating parameters to generate a modeling result; and
normalizing the modeling result into a graphical model representing a formula that expresses the pipeline flow rate as a function of the pipeline diameter and the pipeline pressure.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
determining a correlation relationship between a pipeline pumped-in Normal Flow Rate (NFR) value, a pipeline diameter and a pipeline pressure, wherein the pipeline NFR values, the pipeline diameter and the pipeline pressure are associated with a pipeline transporting hydrocarbons from one location to another;
developing a matrix including a plurality of values of pipeline flow rates, pipeline diameters and pipeline pressures, wherein the matrix comprises a plurality of combinations of the pipeline flow rate, the pipeline diameter, and the pipeline pressure, wherein each of the pipeline flow rate can be determined based on the pipeline NFR value, and wherein each pipeline flow rate value corresponds to a flow rate at which a pipeline having a pipeline diameter flowing hydrocarbons at a pipeline pressure ruptured;
providing the matrix as an input to a dispersion model to obtain a plurality of ½ lower flammable limit (LFL) downwind distance, wherein the ½ LFL downwind distance represents a distance by which the hydrocarbons disperse from a ruptured pipeline; and
determining a pipeline Rupture Exposure Radius (RER) value based on the obtained ½ LFL downwind distance, wherein the RER value is defined by modelling a downwind dispersion distance at a ground level in case of a pipeline full bore rupture to a limit of ½ LFL downwind distance of released vapor, and wherein the determined pipeline RER value is expressed as a function of the pipeline diameter and the pipeline pressure.

16. The computer-implemented system of claim 15, wherein the correlation relationship is determined on a 95% confidence interval based on a regression analysis.

17. The computer-implemented system of claim 15, wherein the pipeline flow rate is 5 times the pipeline NFR value.

18. The computer-implemented system of claim 15, wherein determining a correlation relationship between a pipeline NFR value and a pipeline diameter and a pipeline pressure comprises:
determining a correlation relationship between a pipeline diameter and a pipeline NFR value; and
determining a correlation relationship between the pipeline NFR value, the pipeline diameter, and a pipeline pressure, wherein the pipeline NFR value is expressed as a square root of the pipeline pressure multiplied by the pipeline diameter squared.

19. The computer-implemented system of claim 15, wherein the pipeline RER value is determined based on RER=20×(D²×\sqrt{P})^{0.3}, wherein D is the pipeline diameter and P is the pipeline pressure.

20. The computer-implemented system of claim 15,wherein modeling the matrix by a dispersion model comprises:
receiving a plurality of predetermined operating parameters, wherein the plurality of predetermined operating parameters are associated with a pipeline failure analysis;
modeling the matrix by a dispersion model based on the received plurality of operating parameters to generate a modeling result; and
normalizing the modeling result into a graphical model representing a formula that expresses the pipeline flow rate as a function of the pipeline diameter and the pipeline pressure.
